(19) United States
(12) Patent Application Publication
(10) Pub. No.: US 2025/0128848 A1
(43) Pub. Date: Apr. 24, 2025

(54) BIB TIE AUTOMATION SYSTEM

(71) Applicant: Bedford Industries, Inc., Worthington, MN (US)

(72) Inventors: Trevor Wintz, Round Lake, MN (US); Jaden Balster, Adrian, MN (US); Troy Lang, Fulda, MN (US)

(21) Appl. No.: 18/684,959

(22) PCT Filed: Aug. 22, 2022
(86) PCT No.: PCT/US2022/041041

§ 371 Date: Feb. 20, 2024

Related U.S. Application Data
(60) Provisional application No. 63/236,109, filed on Aug. 23, 2021.
(60) Provisional application No. 63/308,694, filed on Feb. 10, 2022.

(51) Int. Cl. B65B 51/08; B65B 13/18; B65B 13/28; G09F 3/14

(52) U.S. Cl. CPC B65B 51/08; B65B 13/182; B65B 13/28; G09F 3/14

(57) ABSTRACT

A ring is configured for use with an automated tying machine with a twist tie and tag. The ring includes a channel through which the twist tie is configured to travel, a first guide, and first and second surfaces. The first guide includes a tip and first and second inclined sides extending from the tip. The first and second surfaces are spaced from portions of the first and second inclined sides, respectively. A system for automatically banding and tagging a product includes a tying machine and a tag feeding assembly. The tying machine is configured to band the product with a twist tie. The tag feeding assembly is configured to position an attachment portion of a tag into a ring of the machine.

### BACKGROUND

Merchandise of many different types is banded in one way or another for packaging or preparing the merchandise for movement in channels toward the ultimate presentation and marketing to the consumer. For example, a twist tie may be placed about the mouth of a bag or about a container of merchandise or about multiple containers. The twist tie may also be placed directly around the merchandise itself, such as to bundle a grouping of agricultural produce or around a single item of merchandise (for example, a rolled or folded newspaper or coiled hose or cable).

Labeling or marking of merchandise with printed matter is also often desirable to provide information to various entities in the production and marketing channels as well as to the ultimate consumer. The printed matter may provide information regarding merchandise identification and price and may take the form of, for example, machine readable or scannable material (such as codes comprised of bars or characters or other markings) and human readable material (such as characters and graphical or pictorial matter). In modern mass merchandising outlets such as discount stores or supermarkets, there has been an almost complete movement toward labeling products (or the packaging thereof) with an identification code, such as a Universal Product Code (UPC) or Quick Response (QR) Code, which includes a bar or graphical code readable by an electronic scanner, smart phone, or other device.

Additionally, other printed matter (besides the UPC bar code) may also be associated with the merchandise items. For example, in the particular case of agricultural produce, a “Product Look Up” (PLU) number identification code, a trademark of the producer and a collective or certification mark may also be displayed. Inclusion of storage directions, serving suggestions and recipes for preparing the particular item may promote sales of the product. Moreover, a table of “Nutritional Facts” and an indication of the place of origin (such as country or state) may be required by law to be marked on the produce.

However, banding and tagging merchandise in a quick, efficient, simple, secure and reliable manner has been an elusive goal. Banding and tagging difficulties have been most serious in the production and marketing of agricultural produce, where problems can arise both during and after the banding and tagging operation is performed; moreover, handling of the produce is further complicated because of its non-uniform nature and configuration.

Bands and tags applied in the agricultural field are subjected to the rigors of a variety of produce processing operations and should remain intact and securely in place on the produce throughout processing, sales display, and scanning at the supermarket checkout counter. Produce processing often includes washing the produce (such as with a high velocity water blast), chilling the produce by dumping ice thereon and/or submersion of the produce in chilled water, and moving the produce (such as by conveyors). Once the produce reaches the supermarket display case, it is unpacked and then often subjected to repeated sprayings with water. After all that handling and processing, the produce must then be displayed in a way that presents an attractive product for consumer selection and purchase (and preferably, appropriately tagged for check-out).

Tags that succumb to the produce processing operations by becoming detached from the twist tie or by appearing excessively worn or tattered are likely to cause rejection of the produce by the grocer and the consumer. Produce buying is generally considered to be highly dependent upon the presentation of a pleasing product appearance to the consumer, and if the condition of a tag on produce appears unattractive, a consumer may be less inclined to buy the produce. As a result, grocers may be less inclined to purchase and display produce with a tag having an unsightly appearance. In a more practical sense, the tag should remain attached to the produce and readable by a checkout scanner until the time of supermarket checkout, and grocers may refuse produce shipments having a significant number of tags missing or in an unscannable condition. Thus, it is desirable to simplify and speed up the banding and tagging of merchandise such as produce with durable tag materials.

### SUMMARY

In one aspect, a ring is configured for use with an automated tying machine with a twist tie and tag. The ring includes a channel through which the twist tie is configured to travel, a first guide, and first and second surfaces. The first guide includes a tip and first and second inclined sides extending from the tip. The first and second surfaces are spaced from portions of the first and second inclined sides, respectively.

In another aspect, a system for automatically banding and tagging a product includes a tying machine and a tag feeding assembly. The tying machine is configured to band the product with a twist tie. The machine includes a ring and a guide, the ring having a channel through which the twist tie is configured to travel. The guide includes a tip and first and second inclined sides extending from the tip. The tag feeding assembly is configured to position an attachment portion of a tag into the ring, wherein the attachment portion is bent around the guide and against the first and second inclined sides, so that a twist tie passing through the channel passes through the attachment portion of the tag.

In yet another aspect, a strip includes a plurality of ruptureably connected tags. A tag of the strip is configured for use with a ring in an automated tying machine with a twist tie, the ring including a channel through which the twist tie is configured to travel and a guide comprising a tip and first and second inclined sides extending from the tip. The tag includes an attachment portion configured for insertion into the ring, wherein the attachment portion is bent around the guide and against the first and second inclined sides, so that a twist tie passing through the channel passes through the attachment portion of the tag.

This summary is provided to introduce concepts in simplified form that are further described below in the Detailed Description. This summary is not intended to identify key features or essential features of the disclosed or claimed subject matter and is not intended to describe each disclosed embodiment or every implementation of the disclosed or claimed subject matter. Specifically, features disclosed herein with respect to one embodiment may be equally applicable to another. Further, this summary is not intended to be used as an aid in determining the scope of the claimed subject matter. Many other novel advantages, features, and relationships will become apparent as this description proceeds. The figures and the description that follow more particularly exemplify illustrative embodiments.

### BRIEF DESCRIPTION OF THE DRAWINGS

The disclosed subject matter will be further explained with reference to the attached figures, wherein like structure or system elements are referred to by like reference numerals throughout the several views. It is contemplated that all descriptions are applicable to like and analogous structures throughout the several embodiments.

FIG. 1 is a perspective view of an exemplary system for automatically attaching a labeling article to a product.

FIG. 2 is a partial top perspective view of the exemplary system.

FIG. 3 is a partial front perspective view, with some elements removed for ease of discussion.

FIG. 4A is a perspective view of a first exemplary ring for use with the tying machine of the system.

FIG. 4B is a perspective view of a second exemplary ring for use with the tying machine of the system.

FIG. 5A is a partial perspective view of mechanisms for feeding a tag strip into a ring.

FIG. 5B is a perspective view of an exemplary cutting pressure plate.

FIG. 6A is similar to FIG. 5A but shows additional elements removed for ease of discussion.

FIG. 6B is a partial perspective view of the tag feeding mechanisms and ring, with the cutting pressure plate removed.

FIG. 6C is a partial top perspective view of components of FIG. 6B.

FIG. 7A is an elevation view of a tag receiving portion of the ring, taken at line 7A-7A of FIG. 6C.

FIG. 7B is a partial cross-sectional perspective view of the ring, taken along line 7B-7B of FIG. 6C.

FIG. 7C is an enlarged portion of FIG. 7B, showing a cross-sectional view of a fully inserted top attachment portion of a tag.

FIG. 7D is similar to FIG. 7C but with the tag removed and viewed from a different perspective.

FIG. 8 is a partial perspective view showing a top portion of a tag of a strip being advanced into a ring.

FIG. 9 is a perspective view of the ring, showing the tag fully inserted therein.

FIG. 10 is a partial perspective view showing a separation line between adjacent tags of the tag web strip, with the cutting pressure plate pivoted downward onto the tag strip for cutting.

FIG. 11 is similar to FIG. 10 but shows that cutting has been completed, and the cutting pressure plate is raised.

FIG. 12 is a perspective view of a portion of a tying machine, wherein a merchandise product is positioned for insertion into an open ring.

FIG. 13 shows the ring closed around the product.

FIG. 14 shows that the ring is open again after the product has been tied and tagged.

FIG. 15 shows a plurality of tied and tagged products; some tags are not visible because they are behind the product.

FIG. 16 is a perspective view of an exemplary system in use with a second exemplary merchandise product.

FIG. 17 is a side schematic elevation view of an exemplary mobile agricultural apparatus.

FIG. 18A is a front view of a portion of a tag strip of web material.

FIG. 18B is a rear view of an exemplary tag.

FIG. 18C is a plan view of a second exemplary tag.

FIG. 18D is a plan view of a third exemplary tag.

FIG. 18E is an enlarged view of the encircled portion of FIG. 18D labeled “E.”

FIG. 19 is a plan view of an exemplary twist tie labeling article.

FIG. 20 is a perspective view of a system having a second exemplary embodiment of a tag feeding assembly.

FIG. 21 is a side elevation view of a tag indexer portion of the system of FIG. 20.

FIG. 22 is a perspective view of a tag strip entry area to the tag indexer.

FIG. 23 is a perspective view showing a tag strip in the entry area to the tag indexer.

FIG. 24 is a perspective view of a tag strip exit area of the tag indexer.

FIG. 25 shows a tag strip in the exit area of the tag indexer.

FIG. 26 is a close view of a tag fully inserted into a tag receiving portion of a ring.

FIG. 27 is a perspective view of a ring with a tag fully inserted into its tag receiving portion.

While the above-identified figures set forth several embodiments of the disclosed subject matter, other embodiments are also contemplated, as noted in the disclosure. In all cases, this disclosure presents the disclosed subject matter by way of representation and not limitation. It should be understood that numerous other modifications and embodiments can be devised by those skilled in the art that fall within the scope of the principles of this disclosure.

The figures may not be drawn to scale. In particular, some features may be enlarged relative to other features for clarity. Moreover, where terms such as above, below, over, under, top, bottom, side, right, left, vertical, horizontal, etc., are used, it is to be understood that they are used only for ease of understanding the description. It is contemplated that structures may be oriented otherwise. Like reference numbers are used for analogous structures (such as 36 and 36′ for different implementations of a product, for example). It is to be understood that descriptions of structures also apply to analogous structures unless otherwise indicated.

### DETAILED DESCRIPTION

This disclosure relates generally to equipment to automate the attachment of a labeling and banding article on a merchandise product, and particularly for simultaneously banding and tagging of the merchandise. In exemplary embodiments, the equipment positions and places a twist tie (having a tag thereon for bearing printed matter) securely about a portion of the product. The economical tag-bearing tie article is easily and quickly applied to merchandise using the disclosed automation equipment. Automation in produce packaging simplifies the motions human workers use, thereby increasing the overall output rate of packaging and decreasing the incidence of repetitive use injuries. The tag-bearing tie article is durable enough to remain intact and securely attached to merchandise and not be smeared or defaced during its movement through production and marketing channels.

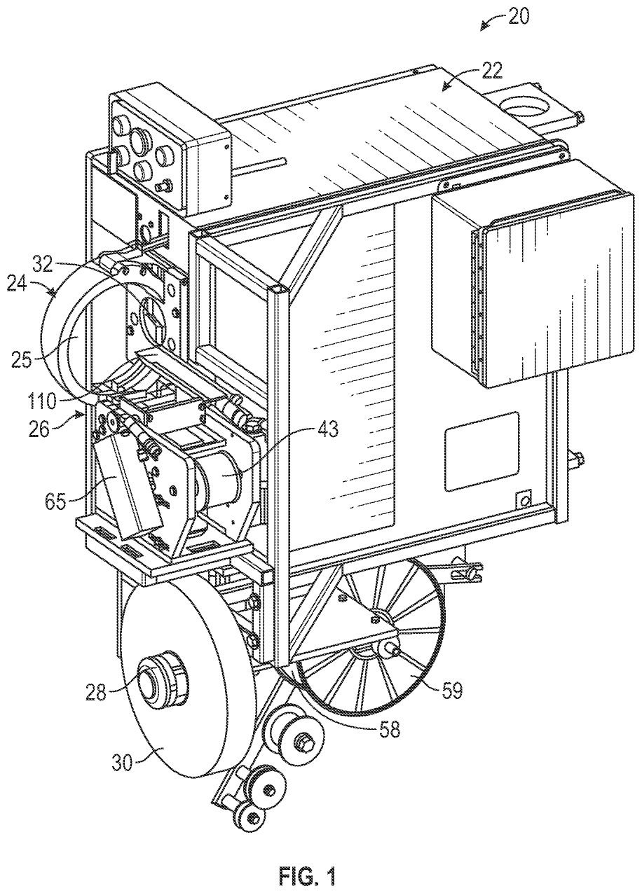

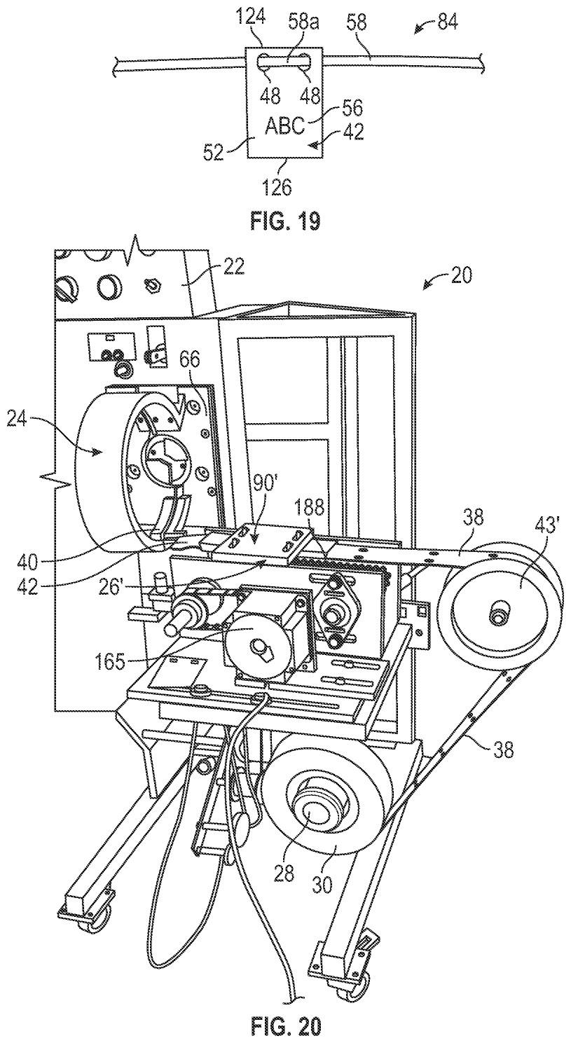

FIG. 1 is a perspective view of an exemplary system 20 for automatically attaching a labeling article to a product. System 20 is configured for automating the attachment of a labeling and banding article 84 (shown in FIGS. 15, 16 and 19, also referred to an as twist tie article 84) on a merchandise product 36, 36′. System 20 in an exemplary embodiment uses machine 22, adapted with a ring 24 of the present disclosure. Machine 22 in an exemplary embodiment is also modified with one or more of a tag feeding assembly 26, 26′, tag supply support 28, and a product shelf 110. In an exemplary embodiment, tag supply support 28 holds a spool 30 of rolled tag strip 38.

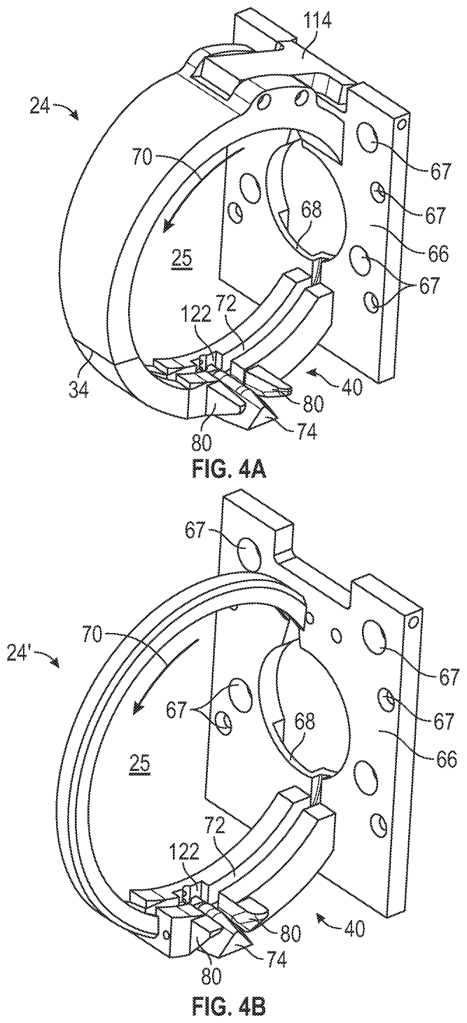

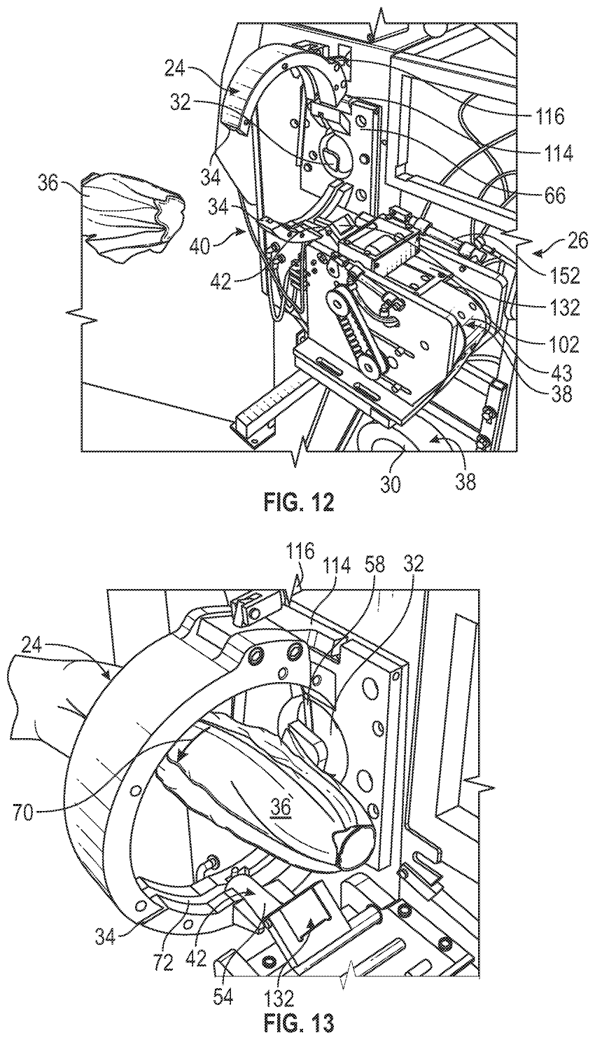

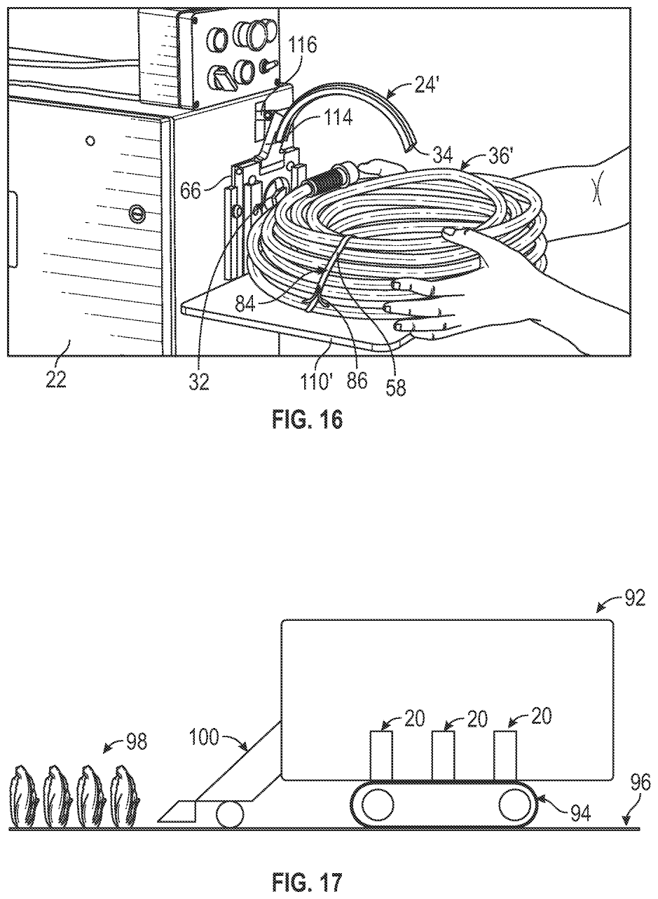

In some instances, similar items may have different configurations. For example, ring 24 of FIG. 4A is wider than ring 24′ of FIG. 4B. Moreover, a product to be labeled and banded by system 20 is referred to generally as product 36. However, FIGS. 12-15 show one embodiment of a product as a lettuce head, given the reference number 36. In contrast, FIG. 16 shows another embodiment of a product in the form of a coiled hose, designated 36′. All descriptions of an element will also refer to other configurations of the element, given similar reference numbers.

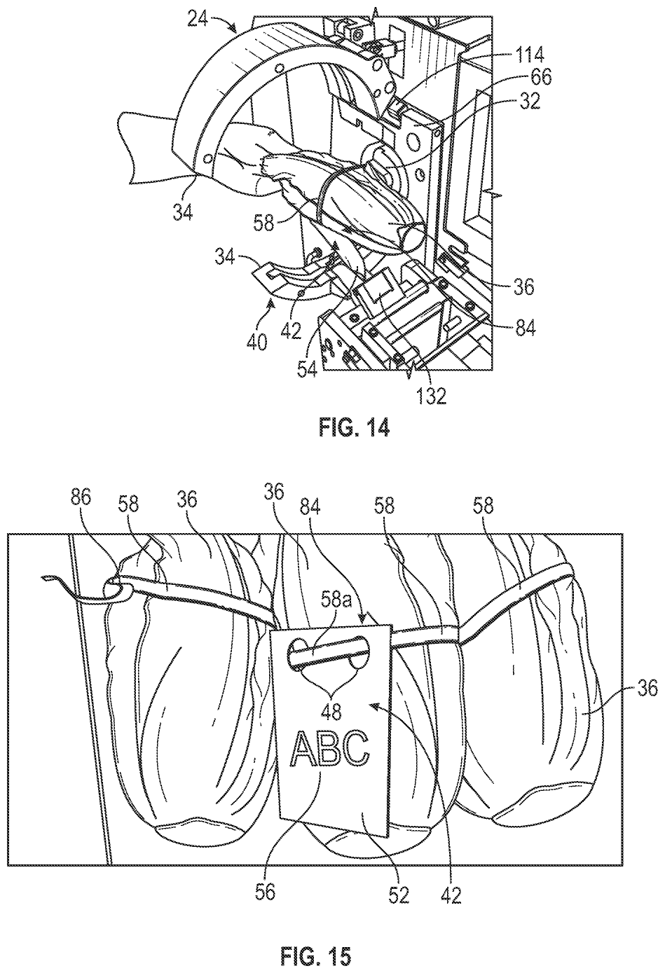

A suitable machine 22 for use in system 20 includes the Ring Tyer™ machine commercially available from Bedford Industries, Inc., of Worthington, Minnesota. The machine 22 feeds a continuous length of twist tie 58 (labeled in FIGS. 1, 13-16 and 19) from a supply such as spool 59 through twisting mechanism 32 and to ring 24. The twist tie 58 travels in a channel 72 on an interior of the ring 24 to surround a product 36, 36′ inserted into the opening 25 of the ring 24. Mechanisms 32 twist and cut the twist tie strip 58 after pulling it tightly around the product or product portion 36, 36′ inserted into the ring 24 (as shown in FIGS. 14-16). In some embodiments, ring 24 has a split 34, allowing it to open for insertion of a portion of product 36 into ring 24 from the front of the machine 22 (rather than inserting the product 36, 36′ into the opening 25 of the ring 24 from the side thereof).

In cases in which the ring 24 has a split 34, the ring is initially in an open position (see FIGS. 9 and 12). At the initiation of each tying operation, the machine 22 closes the ring 24 about the portion of the product 36 to be tied (see FIG. 13). The operation of machine 22 to (1) close the ring 24 (if necessary), (2) feed a length of twist tie 58 around a channel 72 on the inside of the closed ring 24 and thus around the product portion 36, 36′ disposed within the ring 24, and (3) cut and twist the twist tie 58 to form twisted closure 86 (and thus the twist tie labeling article 84 on the product 36, 36′) can be accomplished by means such as by operation of a foot pedal (not shown), for example, or by automatic means, such as a contact sensor triggered by product contact, or optical proximity sensor, for example.

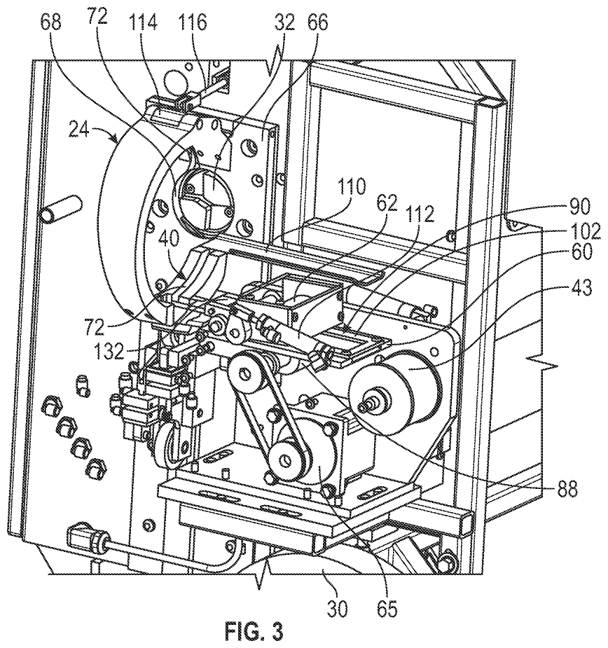

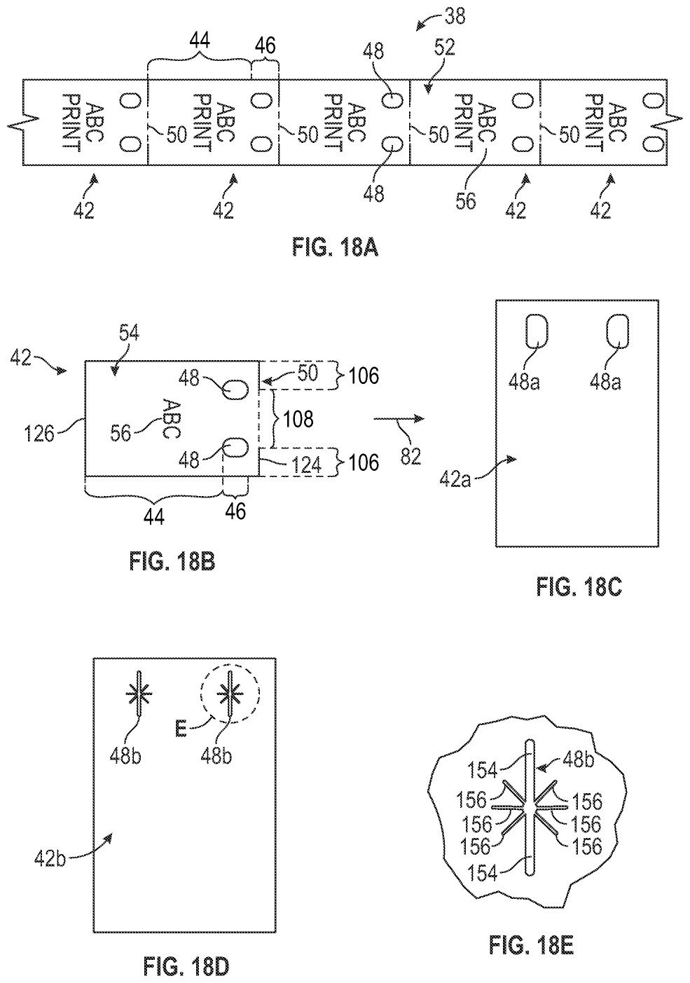

Returning to FIG. 1, for use in system 20, the commercially available machine 22 is modified with a ring 24 and tag feeding assembly 26, 26′ of the current disclosure. In an exemplary embodiment, tag feeding assembly 26 feeds a tag web or strip 38 (shown in FIGS. 12 and 18A) of connected tags 42 into the bottom, tag receiving portion 40 of the ring 24. It is to be understood that although this disclosure sometimes refers to a bottom portion 40 of the ring 24 as illustrated, the ring 24 could be oriented otherwise, so that its tag receiving portion is not at the bottom. The tag strip 38 is routed from spool 30 and around guide roll 43, to align a portion of the tag strip 38 with the tag feeding assembly 26. A motor 65 is configured to rotate drive roller 88 (see FIG. 3).

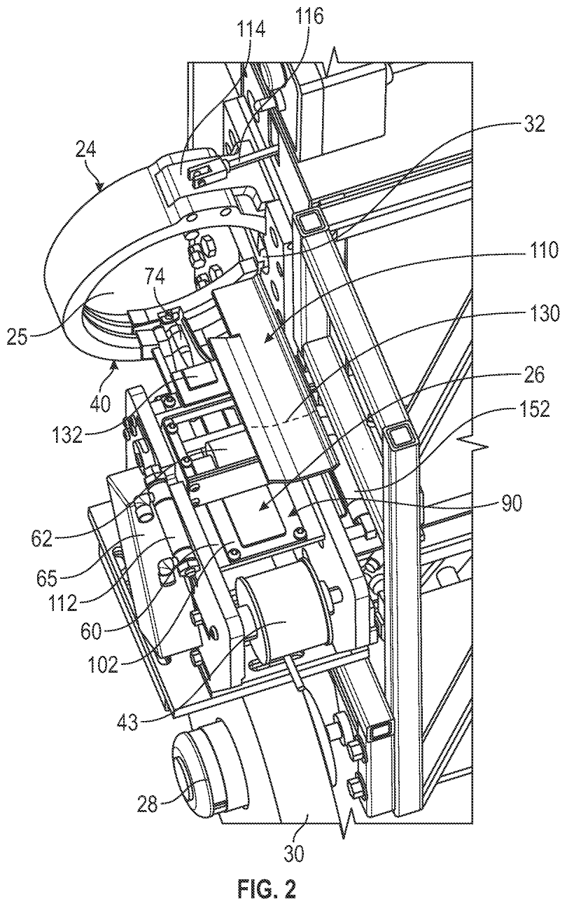

Tag strip 38 is conveyed at a nip between the drive roller 88 and a nip roller 62 positioned above the drive roller 88. In an exemplary embodiment, nip pressure adjustment mechanism 112 is provided to adjust the nip pressure exerted by nip roller 62 on drive roller 88. Thus, the tag feeding assembly 26 can accommodate tag strips 38 made of different materials and having different thicknesses. In an exemplary embodiment, the nip pressure adjustment mechanism 112 is provided in the form of a hydraulic cylinder, though other devices can be used. As shown in FIGS. 2, 3, 5A and 6A, plate assembly 90 includes track plate 60 and hold plate 102, forming a channel therebetween through which the tag strip 38 is conveyed between guide roll 43 and ring 24.

FIG. 18A is a front view showing a portion of a continuous tag strip 38, comprising a plurality of ruptureably connected tags 42. In an exemplary embodiment, on tag 42, the area of an information portion 44 is greater than an area of an attachment portion 46. In an exemplary embodiment, the attachment portion 46 of a tag 42 is defined as including apertures 48 and extending to the closer of two separation lines 50 to the apertures 48. In an exemplary embodiment, the information portion 44 of a tag 42 is defined as an area not including apertures 48 and extending to the farther separation line 50 from the apertures 48. In an exemplary embodiment, both front surface 52 and rear surface 54 (labeled in FIG. 18B) of the tag 42 can include indicia 56, such as printed matter. In an exemplary embodiment, the information portion 44 and the attachment portion 46 are integral.

In many cases, the tag 42 displays indicia 56, which may include not only human detectable indicia, but also machine detectable indicia (such as a UPC bar code, for example). Provision of indicia 56, such as by printing, embossing, inlaying, or engraving, for example, is accomplished in an exemplary method before tag 42 and twist tie 58 are assembled together. In some cases, the indicia 56 are provided on the tag 42 during tag manufacture. Alternatively or additionally, indicia 56 can be added to tag 42 at the merchandise production or packaging facility to impart more specific information such as a “pick date,” expiration date, farm identification, facility location, block chain authentication code, or lot number, for example.

In descriptions of tag 42, this disclosure will sometimes refer to a “front” surface 52 and a “rear” surface 54. Such terms are used for purposes of describing the structure with reference to the drawings. However, it is understood that either major surface 52, 54 of the tag 42 may face outward toward a viewer when applied to a merchandise product 36, and either or both surfaces 52, 54 of the tag 42 can carry visible or otherwise detectable indicia 56. Surfaces of tag 42 and twist tie 58 may be treated to accept printing thereon or to enhance the visibility or durability of information disposed thereon (e.g., such as by applying a coating thereto). Indicia 56 may be provided on either or both of tag 42 and on twist tie 58. Printing capabilities may also be added to the system 20 by provision of a printer, such as one positioned between guide roll 43 and tag feeding assembly 26, for example.

The web or sheet material of tag strip 38 is preferably tear resistant and ideally is formed from a polymer. Suitable tag material substrates include the following (for example and without limitation): [1] 10 mil (0.25 mm) thick Artisyn™ synthetic paper, product no. UAR 100, available from Protect-All Print Media, Inc., Darrien, Wisconsin, at a width of 8.5 inches (21.59 cm); [2] 7.5 mil (0.19 mm) thick Teslin™ synthetic paper or 7 mil (0.18 mm) SP 700, available from Technicote, Inc., Cuyahoga Falls, Ohio (made by PPG Industries, Pittsburgh, Pennsylvania), at a width of 8.5 inches (21.59 cm); or [3] 4 mil (0.10 mm) thick polyethylene terephthalate (PET) Tairilin film, product nos. CH284, CH885 and Cy18, available from Nan Ya Plastics Corporation USA of Wharton, Texas, at widths of 5-15 inches (12.7-38.1 cm).

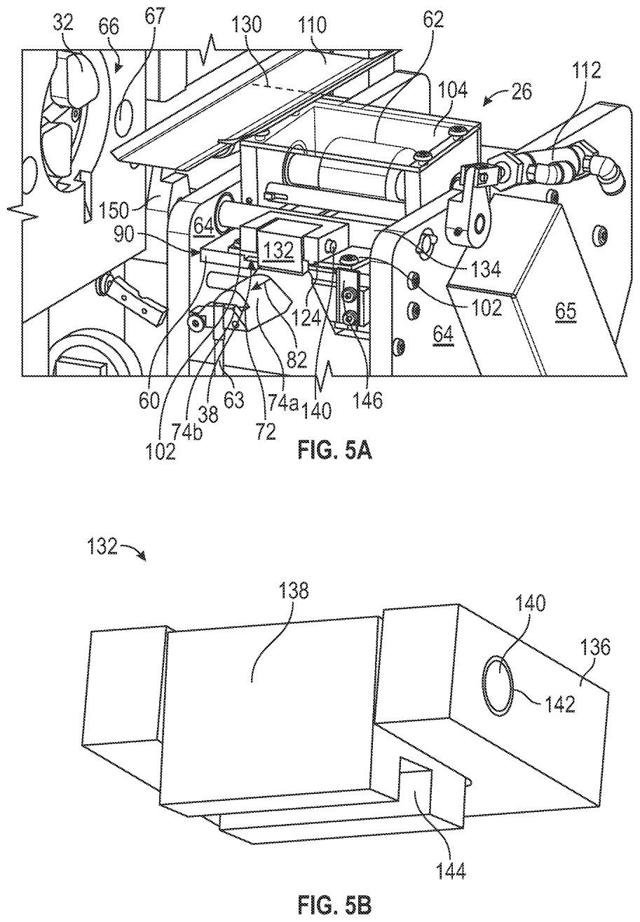

In an exemplary embodiment, tag strip 38 may include weakened separation lines 50 between adjacent ruptureably connected tags 42. Separation line 50 defines the boundary between the leading edge 124 of a tag 42 and the trailing edge 126 of the ruptureably attached adjacent tag 42, wherein the terms “leading” and “trailing” are relative to the tag insertion direction 82 into the tag receiving portion 40 of ring 24 (see FIGS. 5A, 7C and 8). As shown in FIG. 18B, in an exemplary embodiment, separation line 50 includes through cut segments 106 at the sides of tag 42 and a perforated central segment 108. The through cut segments 106 facilitate full separation of a tag 42 from the strip 38 when desired. While the illustrated embodiment shows separations lines 50 formed with perforations, it is contemplated that other configurations of weakened separation lines can also be used, including for example, score lines, cut lines of full or partial depth, and other mechanisms for forming a ruptureable line or contour of weakness. Although the separation lines 50 are illustrated as linear and laterally extending across the strip 38, it is contemplated that the separation lines 50 need not be linear or laterally extending. For instance, the separation lines could be defined as curved lines or serpentine lines between adjacent tags 42. In addition, tags 42 having shapes other than generally rectangular could be formed by die cutting in desired shapes.

FIGS. 18C-18E show other exemplary embodiments of tags 42a and 42b having apertures 48a and 48b. All descriptions of tag 42 and aperture 48 also apply to tags 42a, 42b and apertures 48a, 48b unless stated otherwise. For example, while not explicitly labeled in FIGS. 18C and 18D, tags 42a, 42b also have information portion 44, attachment portion 46, front surface 52, rear surface 54, indicia 56, weakness lines 50 formed with through cut 106 and perforated segment 108, leading edge 124 and trailing edge 126.

In exemplary embodiments, each of tags 42, 42a and 42b has an overall length (between separation lines 50) of about 3 inches (7.62 cm) and an overall width (perpendicular to the length) of about 2 inches (5.08 cm). In an exemplary embodiment, aperture 48, 48a is about 0.40 inch (1.016 cm) long and about 0.25 inch (0.635 cm) wide. In an exemplary embodiment, aperture 48b is about 0.44 inch (1.118 cm) long between the radius ends of primary slit 154 and is about 0.25 inch (0.635 cm) wide between the radius ends of the horizontally shown minor slit 156. In an exemplary embodiment, each aperture 48, 48a, 48b is spaced from about 0.34 inch (0.863 cm) to about 0.38 inch (0.965 cm) from a closest separation line 50 (measured from the center of each aperture). Two apertures 48, 48a, 48b of a single tag 42, 42a, 42b are spaced about 1 inch (2.54 cm) apart from each other (measured from the center of each aperture). Additionally, each cut-through segment 106 is about 0.5 inch (1.27 cm) long, and the perforated segment 108 is about 1 inch (2.54 cm) long. These dimensions are suitable for a particular product, size of ring 24, and width of twist tie 58; it is contemplated that tag dimensions may differ for different implementations of the disclosed system.

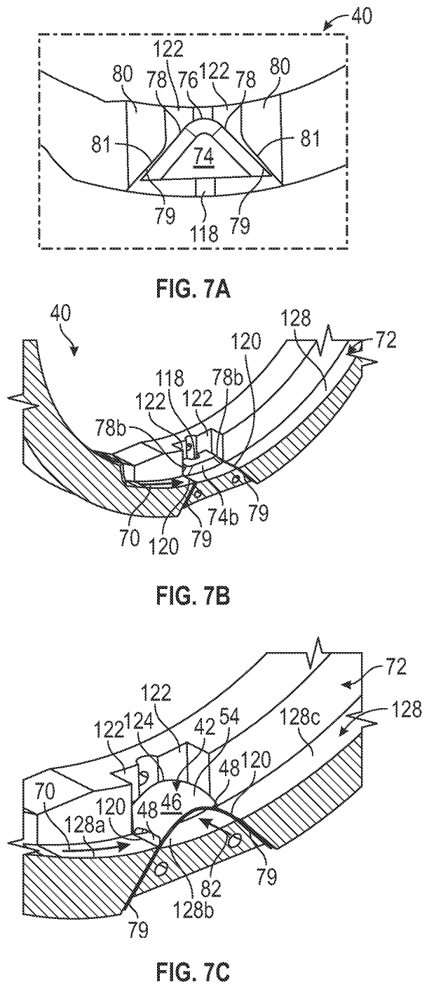

As shown in FIG. 18C, tag 42a has apertures 48a that have a substantially “D” shape, with longer outer straight sides. As shown in FIGS. 18D-18E, tag 42b has apertures 48b that have a plurality of intersecting slits forming a substantially “star” shape. In an exemplary embodiment, primary vertical slit 154 (which in use is aligned parallel with tag insertion direction 82 shown in FIGS. 7C and 7D) is greater in length and width than radiating minor slits 156. In an exemplary embodiment, 45 radial degrees separate each leg of the slits 154, 156.

While the illustrated tag feeding assembly 26 is configured to feed tags 42 to the tying ring 40 in the form of a tag strip 38 of ruptureably connected tags 42, in another embodiment, system 20 could use individual tags 42 that are fed into the tag receiving portion 40 of ring 24 in a different manner. For example, individually presented tags could be provided in a stack of completely separated tags 42, where each tag 42 in that stack is successively fed into alignment in the tag receiving portion 40 of ring 24.

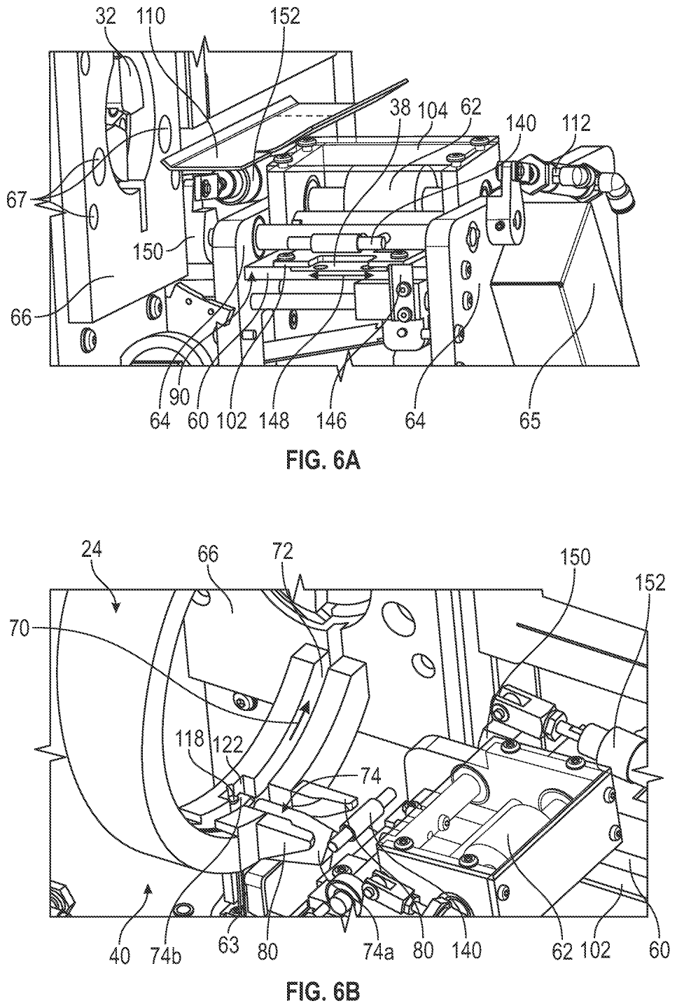

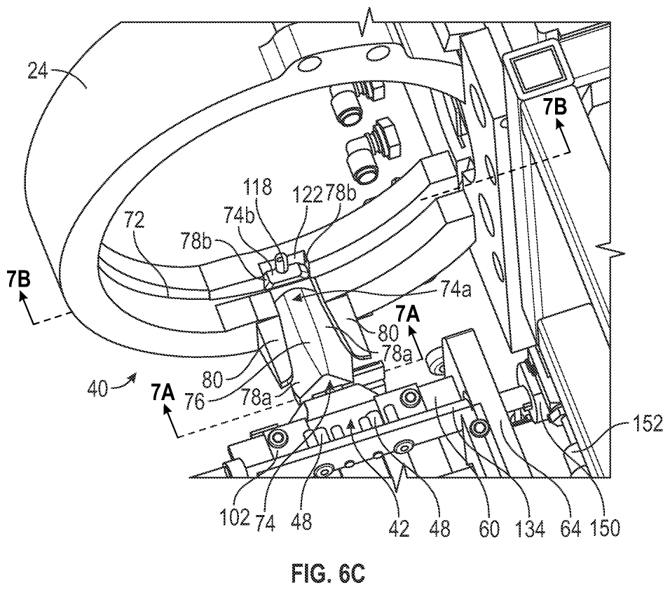

As shown in FIG. 6B, sensor 63 determines when tag 42 has been fully inserted into the tag receiving portion 40 of ring 24. In an exemplary embodiment, sensor 63 is configured as a fiber optic sensor with an optical beam extending through aperture 118. Referring to FIGS. 2 and 3, rollers 62, 88 advance the tag strip 38 along track 60 plate. Plate assembly 90 insures that the tag strip 38 is relatively flat as it approaches the tag receiving portion 40 of ring 24. The drive roller assembly 62, 88 desirably has minimal operational structures, so that the drive is easy to maintain and keep clean, even in an agricultural environment that involves debris such as dirt or foliage. Moreover, a protective housing or shroud can be provided thereover, such as one including at least a cover plate 104 as shown in FIG. 5A.

FIGS. 4A and 4B are perspective views of exemplary rings 24, 24′ to be used with machine 22 in system 20. Accordingly, a user in possession of the commercially available machine 22 can simply trade out components thereof, such as ring 24, and add other components such as tag feeding assembly 26, 26′; tag supply support 28 and spool 30 of tag strip 38; and product shelf 110, 110′ in order to obtain the described automatic tagging system 20. While an unmodified machine 22 only bands merchandise, the described system 20 not only bands but also tags the merchandise inserted into ring 24 with a label (tag 42). As shown in FIGS. 4A and 4B, ring 24, 24′ includes an attachment plate 66 having various fastener apertures 67 therethrough to allow for attachment of ring 24 to a front face of the machine 22. Moreover, plate 66 includes a larger aperture 68 to allow for access of the machine's twisting and cutting mechanism 32 for a twist tie 58 to be fed in direction 70 around a loop channel 72 of ring 24.

In many respects, ring 24 and ring 24′ are very similar and function in substantially the same manner. Accordingly, all descriptions relevant to one ring 24 also applies to the other ring 24′ unless otherwise stated. Notable differences between the rings are that ring 24 is wider than ring 24′. Moreover, ring 24 has a spit 34 and moveable connection 114 at a top end thereof to allow for opening and closing of the ring at split 34. In an exemplary embodiment, the opening and closing of ring 24 at split 34 is accomplished by an actuator 116, such as a hydraulic cylinder pivotally connected to a top portion of the ring 24 (see FIGS. 2 and 3). In contrast, the tag receiving portion 40 of the ring 24 is fixed relative to the tag feeding assembly 26 to provide a tag alignment and attachment platform. Rings 24 can be provided in different sizes to accommodate different sizes of product 36. For example, a 6-inch (15.24 cm) diameter is a common ring size, though rings having 4-inch (10.16 cm) and 9-inch (22.86 cm) diameters could also be used.

Twist tie 58 includes a deformable wire that can be twisted into a closure 86 (see FIGS. 15 and 16) to hold tag 42 onto a product 36, 36′ and also to bundle portions of a product 36 together. In a method of using the commercially available machine 22, a large spool 59 (shown in FIG. 1) of a continuous strip of twist tie 58 is fed through the machine 22 to extend through the cutting and twisting mechanism 32 and into the ring 24 in direction 70 (see FIG. 13). In an exemplary embodiment, the twist tie material 58 is an elongated flat strip or ribbon of paper or polymer sheet material surrounding and encapsulating a deformable deadfold wire, the ribbon having a width of about 5/32 inch (3.97 mm). However, other widths and many thicknesses of the wing material for twist tie 58 are suitable. In an exemplary embodiments, modifications in tag feeding assembly 26 and in ring 24, including changes in geometry, can be made to accommodate different sizes and shapes of twist tie 58 and tag 42. In an exemplary embodiment, the twist tie 58 lacks distortion memory such that securing a band of the twist tie 58 about merchandise 36 is reliably accomplished by twisting a section of the twist tie with another section of the twist tie using only a 180 degree rotation motion applied to the sections of the twist tie, resulting in twisted closure 86, labeled in FIGS. 15 and 16.

A common type of twist tie 58 includes a length of metal wire enclosed in a covering material of plastic or paper. However, metal-wire twist ties may be undesirable for use in some applications. For example, when food is commercially packaged for distribution to the public, it is desirable for the packaging to allow inspection of packaged food for contamination by foreign objects. One common method of inspecting food products involves the use of metal detectors to confirm that no metal scrap or shards have inadvertently been incorporated in the food product during production or packaging of the food product. Metal-wire twist ties preclude such use of a metal detector, since each package that is closed with a metallic wire twist tie would typically generate a response by the metal detector indicating the presence of metal on the food package. Thus, rather than simply detecting the presence of any undesired metal in the packaged food, the metal detector would also indicate, for each package, the presence of the metal-wire twist tie.

Thus, a polymeric twist tie 58 can be used including a polymeric wire comprising at least about 90% by weight of a high density polyethylene and having an average cross-sectional area ranging from about 0.3 square millimeters to about 1.0 square millimeter. An exemplary polymeric retention article exhibits a tying memory value less than 0.10 inch (2.54 mm) pursuant to a Tying Memory Test and exhibits a tying break value of less than two breaks per 50 attempts pursuant to a Tying Break Test.

FIG. 5A is a perspective view of portions of tag feeding assembly 26, showing a leading edge 124 of a leading tag of a tag strip 38. The ring 24 has been removed from this view to allow for viewing of other features. Tag strip 38 travels in tag insertion direction 82 through a channel provided between track plate 60 and hold plate 102. Cutting pressure assembly 132 is pivotally connected to support 64 at axle 134. As shown in FIG. 5B, in an exemplary embodiment, cutting pressure assembly 132 includes frame 136 partially surrounding knife guide 138. As shown in FIGS. 5A and 5B, these parts are connected by a pivot pin 140 extending through aligned apertures 142. A lower surface of knife guide 138 includes groove 144 for the passage of knife 146.

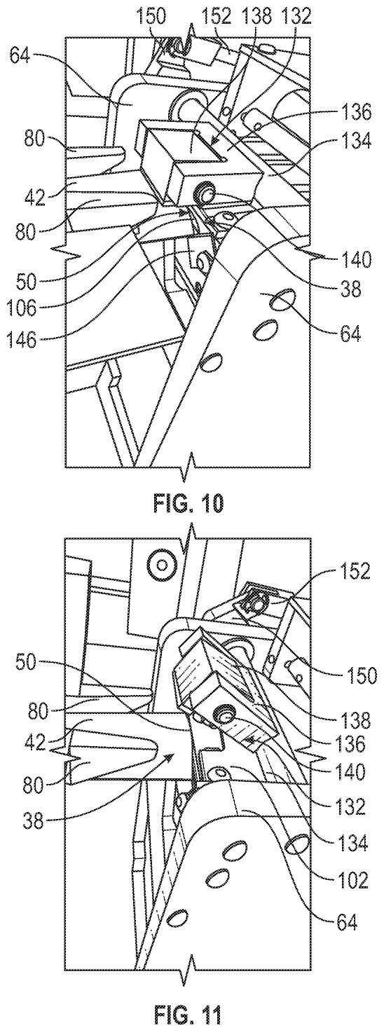

FIG. 6A is a perspective view similar to FIG. 5A, but with the cutting pressure assembly 132 removed so that the movement mechanisms for knife 146 are more clearly visible. Referring also to FIGS. 10 and 11, when the cutting pressure assembly 132 is in the lowered position as shown in FIG. 5A, it supplies downward pressure on a tag strip 38 disposed below it, to hold the strip 38 down so that knife 146 can separate adjacent tags by cutting along separation line 50. The knife blade travels in a reciprocating motion along directions 148, and within channel 144 of knife guide 138, to provide a clean separation of the leading tag 42 from the tag strip 38 at separation line 50. The cutting edge of the knife blade can have different orientations, such as the vertical orientation shown in FIGS. 5A and 6A, and the inclined orientation shown in FIG. 10, wherein a top end of the blade is tilted towards the cutting pressure assembly 132.

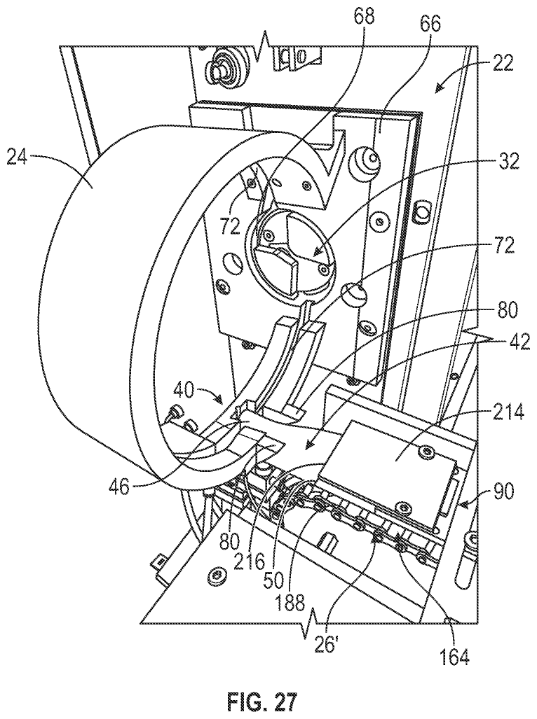

FIGS. 6B-7D show views of an exemplary tag receiving portion 40 of the disclosed ring 24. In an exemplary embodiment, ring 24 includes channel 72 through which twist tie 58 travels in direction 70 around an interior of ring 24. As shown in FIGS. 3 and 27, in an exemplary embodiment, channel 72 is oriented slightly helically (thus not parallel to a vertical plane). Where the channel 72 meets aperture 68 of ring attachment plate 66, the illustrated embodiment shows that the top of channel 72 is to the left of center of twisting mechanism 32, while a bottom of channel 72 is to the right of center of twisting mechanism 32. FIGS. 7B-7D are cross-sectional views taken through line 7B-7B of FIG. 6C. Tag receiving portion 40 also includes saddle 74, which has portions on both sides of channel 72 for supporting a tag 42 as it enters tag receiving portion 40. In an exemplary embodiment, saddle 74 is configured as a substantially triangular prism having a rounded tip or apex 76 and inclined sides 78 extending from the tip 76. Moreover, in an exemplary embodiment, tag receiving portion 40 includes a surface 81 (such as a bottom surface of a projection or finger 80) over each of the inclined sides 78 to bend a tag over or around the apex 76 of saddle 74 as the tag is inserted into the tag receiving portion 40. Inclined sides 78 extend (such as downward below the surface of channel 72) into respectively associated grooves 79 to accommodate the width and thickness of tag 42 at attachment portion 46. In an exemplary embodiment, each of the fingers 80 includes a lower ramp surface 81 extending into its respective groove 79. As shown in FIGS. 7A-7D, grooves 79 extend from saddle 74 and fingers 80, through channel 72, and to back wall 122, which is proximate sensor 63 and sensor aperture 118.

Particular structures are illustrated and described for guiding attachment portion 46 of tag 42 into a tag receiving portion 40 of ring 24 to allow a twist tie 58 traveling through channel 72 to be inserted into apertures 48 of tag 42. However, other structures may be provided to accomplish this function. For example, while first guide or saddle 74 is illustrated as an element with a generally rounded triangular shape, a guide for tag 42 could have a different configuration. Moreover, while upper guides for tag 42 are illustrated as two projections or fingers 80 spaced from the inclined sides 78a, 78b, the curved guiding surfaces 81 could be disposed on a different structure. The fingers or projections 80 may be static as shown, or may be movable (such as spring-loaded, for example) to allow for clearing of debris that may accumulate in grooves 79. Additionally, the guiding surfaces 76, 78, 81 need not be continuous as shown; rather, they can be formed of a series of pins, rods, or other elements that could be adjusted to different contours, for example. There are many ways in which the complementary guiding surfaces 76, 78, 81 can lead to channels or grooves 79 for the precise placement of tag 42 in ring 24.

In an exemplary embodiment, saddle 74 is split into two portions separated by the channel 72. As shown in FIGS. 6B and 6C, saddle 74 has a proximal portion 74a adjacent fingers 80 and a distal saddle portion 74b which has partial inclined sides 78b, which may be similar is shape to the inclined sides 78a of proximal saddle portion 74a (in other embodiments, the inclination orientations of sides 78b may be different, such as inclined more or less, from those of sides 78a). However, distal saddle portion 74b does not have an apex; rather, a top surface accommodates detection aperture 118 for operation of sensor 63. In an exemplary embodiment, sensor 63 sends an optical beam upward through aperture 118 to determine when tag 42 has been fully inserted into tag receiving portion 40, by virtue of its interruption of the optical beam. Other suitable sensors 63 may operate by other mechanisms to determine the presence of a fully inserted tag 42.

FIGS. 7C and 26 illustrate tag 42 inserted fully into the tag receiving portion 40 of ring 24 in insertion direction 82, with its attachment portion 46 bent over saddle 74 and under guiding surfaces 81. Moreover, parts of tag attachment portion 46 of tag 42 are disposed through grooves 79. A leading edge 124 contacts back wall 122, and tag 42 is positioned with apertures 48 of its attachment portion 46 aligned in channel 72. Accordingly, when twist tie 58 travels along channel 72 in direction 70, the twist tie 58 will be automatically inserted through the apertures 48. The attachment portion 46 of tag 42 is bent into shape for proper placement of apertures 48 at channel 72. Tag 42 has an appropriate balance of flexibility and rigidity to retain that shape even though distal saddle portion 74b does not have an apex. The side of the tag 42 facing the viewer is the rear surface 54, as it will face and lie against a product 36 inserted into the ring 24 (see FIGS. 13-15).

As shown in FIGS. 7C and 7D, in an exemplary embodiment, channel floor 128 has a change in elevation or dip 120 at each groove 79 to present a different height in tie travel direction 70. One dip 120 is positioned at each intersection of groove 79 with the floor 128 of channel 72. Thus, a level of floor section 128a is a bit higher (when oriented as illustrated) than a level of floor section 128b at dip 120. Similarly, a level of floor section 128b is a bit higher than a level of floor section 128c at dip 120. These dips 120 insure that a twist tie 58 traveling on the floor 128 in direction 70 is not caught or stopped by the crack leading to groove 79. Stated another way, floor 128 steps down at each groove 79 to minimize a possibility of jamming of twist tie 58 in channel 72.

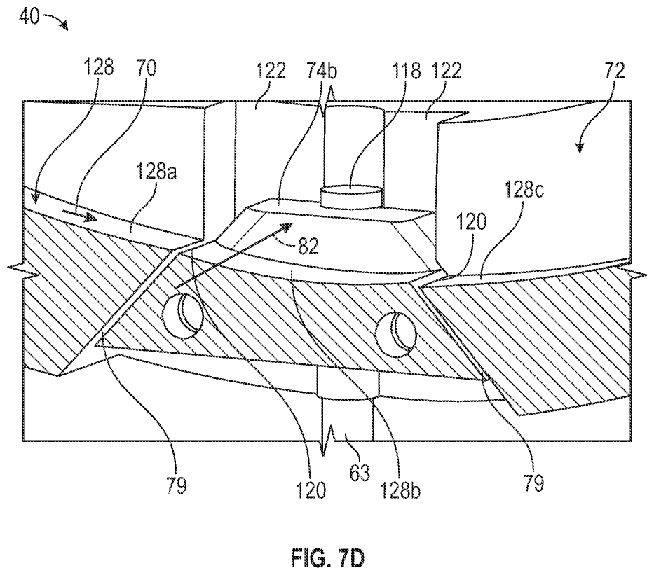

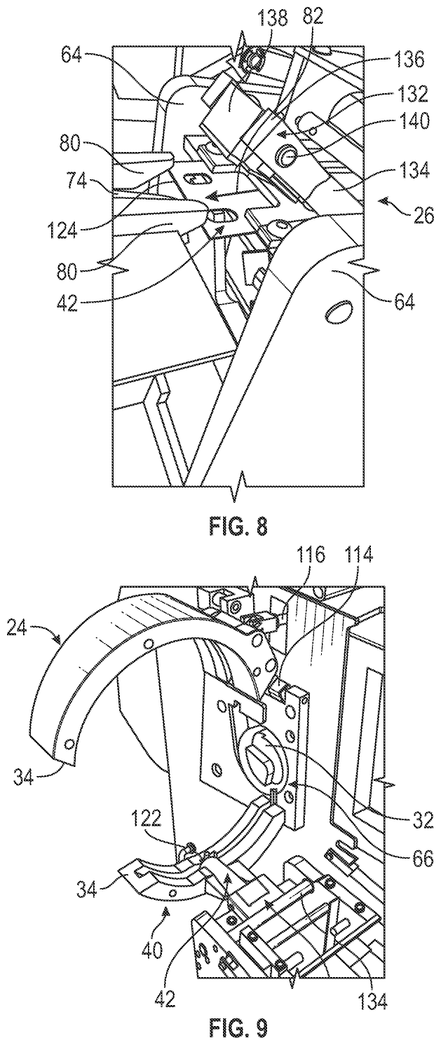

FIG. 8 shows an initial step in an automated product banding and tagging operation. The tag feeding assembly 26 advances a first tag 42 of tag strip 38 in feed direction 82. The cutting pressure assembly 132 is pivoted upward about axle 134 to allow the tag 42 to move thereunder. FIGS. 9 and 26 shows tag 42 fully inserted into the tag receiving portion 40 of ring 24, wherein the leading edge 124 of tag 42 contacts back wall 122 and triggers sensor 63. This triggering of sensor 63 indicates full insertion of tag 42 into the tag receiving portion 40, thereby positioning apertures 48 of tag 42 as shown in FIGS. 7C and 26, for receipt of a twist tie 58 therethrough. As shown in FIGS. 9 and 10, once tag 42 is fully inserted into tag receiving portion 40 of ring 24, cutting pressure assembly 132 pivots downward on axle 134 to place the bottom surface of knife guide 138 against a top surface of tag 42. A pivotal connection between knife guide 138 and frame 136 is provided at pivot pin 140 to accommodate different thicknesses and rigidities of tag strip material, in order to impart sufficient pressure but not wrinkle or deform the tags 42. The pivoting of cutting pressure assembly 132 about axle 134 is accomplished by a cam link 150 pivotally connected to axle 134 on one end and to actuator 152 on the other end. As shown in FIG. 12, actuator 152 is an extendable cylinder, such as a hydraulic cylinder, for example.

As shown in FIG. 10, the cut through segments 106 of separation line 50 are bent downward on the inserted tag 42 by surfaces 81 of fingers 80. Thus, knife 146 easily passes through the through cut segments 106 and along the perforated segment 108 of separation line 50 to cut apart the inserted tag 42 and the next tag 42 of the tag strip 38. This cutting is accomplished by the reciprocating motion of the knife 146 in direction 148, as explained above with reference to FIG. 6A. During the cutting motion, knife 146 travels in the clearance of groove 144 of knife guide 138, shown in FIG. 5B. As shown in FIG. 11, once the cut is made at separation line 50 between the first and second tags 42 of tag strip 38, the cutting pressure assembly 132 pivots upward on axle 134 to allow the cut tag 42 to be removed from the system after attachment to a twist tie 58.

FIG. 12 shows a product 36 positioned for insertion into ring 24. As explained above, a first tag 42 positioned in tag receiving portion 40 of ring 24 has been cut from tag strip 38 and is ready for banding to product 36. As shown in FIG. 13, once product 36 has been inserted into ring 24, in a ring with split 34, the ring closes such as by actuator 116 around the product 36. In other ring configurations that do not have a spilt, no closure step is performed. A length of twist tie 58 emerges from twisting mechanism 32 and travels around an interior of ring 24 in channel 72, following direction 70. As explained above with reference to FIGS. 7A-7C, the twist tie 58 passes through apertures 48 of tag 42. An end of the twist tie returns to mechanism 32, which then cinches the twist tie 58 around product 36 and cuts and twists free ends of the twist tie 58 to form twisted closure 86 secure labeling article 84 to the product 36.

As shown in FIG. 14, this operation results in the simultaneous banding and tagging of the product 36 with labeling article 84. In an exemplary embodiment, article 84 comprises a tag 42 having twist tie 58 inserted through one or more apertures or openings 48 of the tag 42. As shown in FIGS. 14-16, twist tie 58 has been cinched around the article 36, cut to an appropriate length, and twisted closed with closure 86. The twisted closure 86 of the twist tie 58 secures the article 84 onto the product 36. The article 84 includes a visible expanse 58a of twist tie 58 between the two apertures 48 of tag 42 (see FIG. 15).

As shown in FIG. 13, product 36 can be inserted into a ring 24 from a side thereof, thereby not requiring split 34. However, as shown in FIG. 16, some products (such as a coiled hose designated as product 36′) are most efficiently banded with a twist tie 58 that travels through an interior of the product. In this case, opening and closing of ring 24 by actuator 116 at moveable connection 114 allows a portion of the product 36′ to be inserted into the ring 24 at the open split 34.

FIG. 14 shows a completely tagged and banded product 36, with ring 24 open again for easy removal of the product 36, now bearing a twist tie labeling article 84 attached thereto. An advantage of the disclosed system 20 is that an appropriate length of twist tie 58 is used for each product 36. Thus, smaller products will use a shorter length of twist tie 58, and larger (in diameter, for example) products will use an appropriately longer length of twist tie 58 to circumscribe the product and accommodate a secure twisted closure 86. Thus, twist tie 58 is used efficiently with no waste, compared to other tying methods that use pre-cut lengths of tie material. While FIGS. 12-14 do not show product shelf 110, 110′, such a shelf can be useful for the consistent placement of product 36, 36′ to be tied and tagged, especially products that have a longer length or bulky shape. While all of the products depicted in FIG. 15 carry a twist tie labeling article 84, a tag 42 for some of the products 36 is behind the product and therefore is not visible, so that other features, such as twisted closure 86 are visible.

This disclosure describes system 20 that uses machine 22 to automate the simultaneous banding and tagging of merchandise 36, 36′ with a twist tie labeling article 84. The article 84 comprises an elongated twist tie 58 for banding about merchandise 36, 36′ and a tag 42 for labeling the merchandise 36, 36′. Tag 42 has an information portion 44 for displaying indicia 56 thereon and an attachment portion 46 for attaching the twist tie 58. In an exemplary embodiment, the tag 42 comprises a single continuous panel of water resistant sheet material that is initially separate from the twist tie 58. In exemplary embodiments, labeling article 84 is strong enough to withstand the rigors of transport and handling, and retain itself in position on the product 36, 36′ without damage to labeling article 84 or product 36, 36′. Suitable applications for the labeling articles 84 described herein include, but certainly are not limited to, the wrapping and labeling of produce (bundles of carrots, leafy produce, asparagus or floral bouquets, for example), the wrapping and labeling of coiled products (for example, garden hoses, cables and jumping ropes), and the bundling and labeling of industrial products (for example, lengths of pipe, other elongated members such as rebar or threaded rods, and larger bolts and other fasteners).

Web-based processing may be used for the manufacture of tag 42 and twist tie 58 from a standpoint of economy, although batch processing and conveyor processing with indexing from station to station for specific operations can be useful (especially for uniquely designed or shaped tags). In web-based processing, the strip 38 of tag material is optionally given a surface treatment such as a corona surface treatment to enhance printing ink adhesion. The strip 38 can be repetitively printed with informational matter as intended for indicia 56 on each tag 42 to be later excised from the strip 38.

In the illustrated embodiments, an exemplary tag distribution configuration is shown, in which strip 38 is spooled into roll 30. Individual tags 42 can be removed from the strip 38 that forms the roll 30 as desired at separation lines 50. A force to be applied to the strip 38 to separate the ruptureably attached tag 42 at separation line 50 can be applied in a number of different ways. For example, the force applied to the twist tie 58 as mechanism 32 pulls it for cutting and twisting may be enough to sever an attached tag 42 from the tag strip 38. Alternatively, a cutter such as a laser, rotary cutter, or knife blade can be provided on the tag feeding assembly 26 to sever an individual tag 42 from the strip 38 as it is inserted into the tag receiving portion 40 of the ring 24.

While a particular configuration of ruptureably connected tags 42 in a strip 38 is illustrated, it is contemplated that many different configurations of tags 42 can be used. For example, while two apertures 48 of oval configuration are shown, other aperture configurations can also be used, such as D-shaped, circular, square, or rectangular, for example. Moreover, while two discreet apertures are shown in an interior of a tag surface, openings for passage of twist tie 58 can be instead provided by slots that extend to a perimeter of the tag 42. In any case, apertures 48 or equivalent slots preferably allow for passage of twist tie 58 therethrough without interfering with surrounding material of tag 42. This allows for smoother operation of machine 22 and prevents damage to tag 42 as well as disruptions in operation that may be caused by improper threading or jamming of twist tie 58 through apertures 48. In an exemplary embodiment, the apertures 48 are no larger than necessary for reliable operation, because a closer fit of twist tie 58 through aperture 48 leads to a more stable twist tie labeling article 84, in which the tag 42 is securely held on the product 36. Moreover, close tolerances between the twist tie 58 and the aperture 48 lead to a more reliable assembly configuration, in which tags 42 of similarly tagged articles 36 appear uniform in orientation with little tilt or other placement variation.

FIG. 17 is a side elevation view of an exemplary mobile agricultural apparatus 92, such as a harvesting platform, for example. One of the most efficient environments for banding and tagging produce is in the agricultural field relatively soon after the produce is harvested (but usually prior to any significant processing of the produce). The task of banding and tagging the produce in the agricultural field typically falls upon agricultural field workers. A field worker may perform this task hundreds of times each day and is typically paid on the basis of total daily output (and not on the basis of the time spent performing these tasks). As a result, the field workers strongly favor techniques of banding and tagging articles that are quick and simple to apply to produce (and they may resist or refuse techniques that require excessive time or effort). An exemplary harvesting platform apparatus 92 includes a ground engaging mechanism 94 such as a track or wheels for traveling over a field ground surface 96. The mobile apparatus 92 includes a plurality of automated systems 20 for applying twist tie labeling articles 84 to crop merchandise in the field.

In an exemplary method, agricultural product 98 is processed by harvester 100. A worker on the platform apparatus 92 prepares the product if necessary before insertion of a portion of the product into ring 24 of system 20. Such preparation may include aligning several stalks of the product in a bundle and cutting off an end of the bundle, for example. In some embodiments of system 20, as shown in FIGS. 1-3, 5A and 6A, product shelf 110 is provided to assist a worker in placing product 36 so that a portion thereof extends into the open space 25 of ring 24. Shelf 110 can be especially helpful when a plurality of products are to be gathered into a bundle. The appropriate number or size of items can be collected on shelf 110 until the target size of a bundle is ready for banding and tagging. Moreover, the user may provide an end marking 130 on shelf 110, as shown in FIG. 2. Thus, the user has a visual indication of where to position an end of a bundle or merchandise item. This facilitates uniformity in the position of article 84 along a length of a merchandise product or article 36. Such uniformity is often desirable for ease of handling and pleasing display aesthetics of the tagged and banded merchandise. As shown in FIG. 6A, shelf 110 can also serve as a protective shroud to cover actuator 152, link 150, and associated mechanisms.

Preparation steps will vary depending on the specific product. The worker inserts a portion of the product 36 into the ring 24 and actuates the automated tagging and labeling function of the machine to secure a twist tie labeling article 84 around the product. In an exemplary embodiment, mobile apparatus 92 is self-powered, and systems 20 are connected to the power source of apparatus 92. In other embodiments, systems 20 can be located on a trailer traveling along with harvesting or other agricultural equipment. While some descriptions refer to an agricultural platform, system 20 can be used in other environments, such as in automation equipment for industrial use, such as with robotics, conveyors or other higher automation functions, such as for combining parts or bundling items together. Suitable items for receiving twist tie labeling articles 84 include elongated items like pipes, rods or tubing, and items to be banded together, such as components of kits, for example.

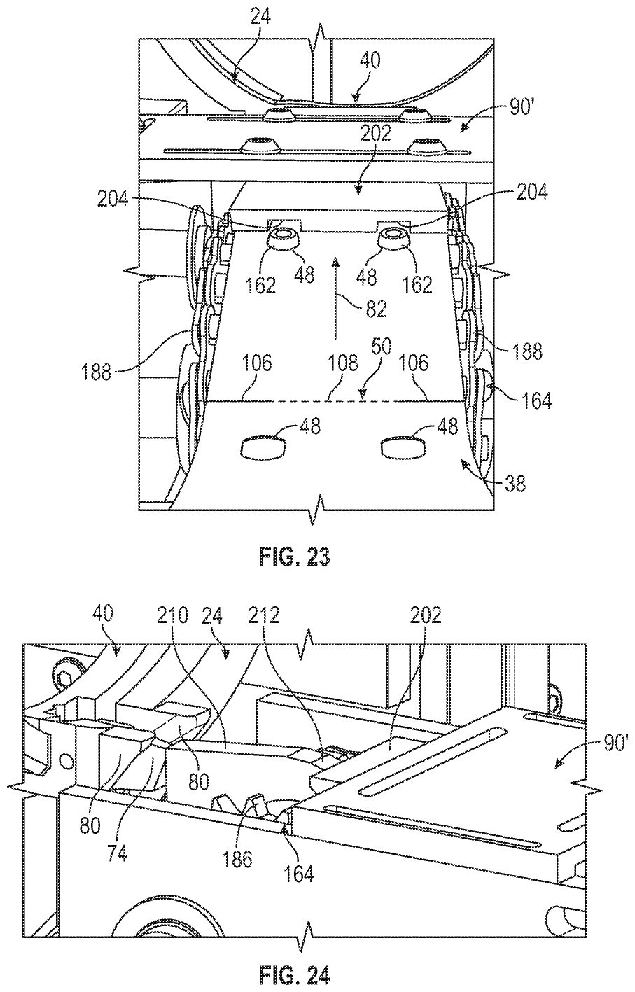

FIGS. 20-27 show a second exemplary embodiment of a tag feeding assembly 26′, which feeds a web of connected tags 42 of tag strip 38 onto the tag receiving portion 40 of the ring 24. FIG. 20 shows a guide roll 43′ about which the tag strip 38 is routed from spool 30, to align a portion of the tag strip 38 with the tag feeding assembly 26′. In an exemplary embodiment, tag feeding assembly 26′ includes pins 162 configured for engagement with apertures 48 of tag strip 38. A pin drive mechanism 164 advances the tag strip 38 from the spool 30 and guide roll 43 toward the tag receiving portion 40 of ring 24. Sensor 63 determines when tag 42 has been fully inserted into the tag receiving portion 40 of ring 24. In an exemplary embodiment, sensor 63 is configured as a fiber optic sensor.

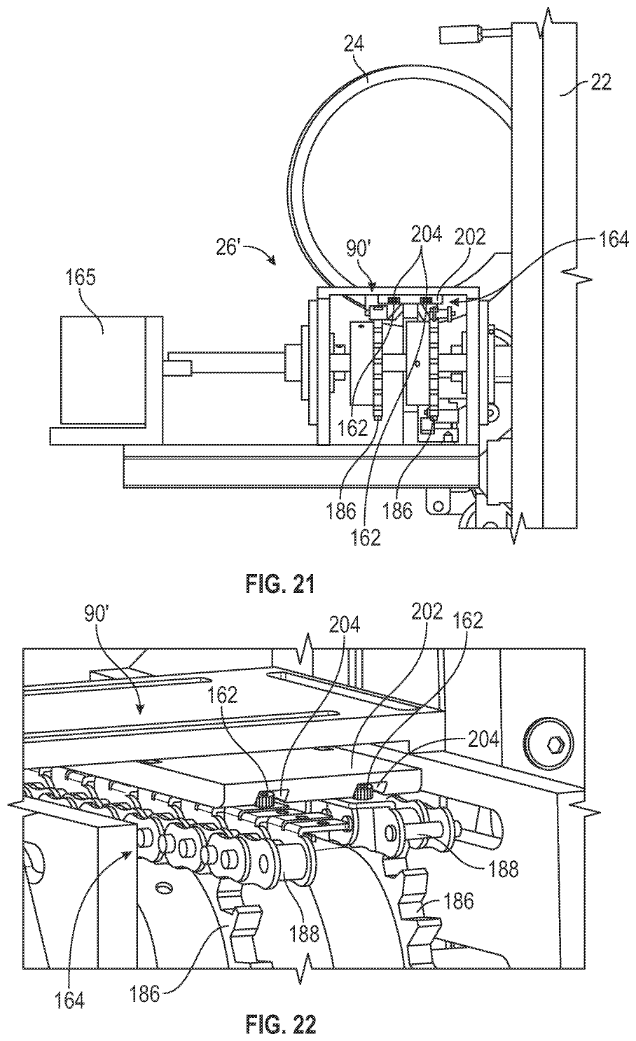

In an exemplary embodiment, motor 165 is configured to turn drive sprockets 186, which in turn advance the endless conveyor chains 188, to which pins 162 are connected for advancing tag strip 38. Plate assembly 90′ insures that the tag strip 38 is relatively flat as it approaches the tag receiving portion 40 of ring 24. As shown in FIGS. 21-23, a plate assembly 90′ includes a hold plate 202 having grooves 204 on a bottom surface thereof through which pins 162 travel. The bottom surface of plate 202 outside of the grooves 204 holds down tag strip 38 and ensures that apertures 48 of the tag strip do not pop off the pins 162. The pin drive mechanism 164 desirably has minimal operational structures, so that the drive is easy to maintain and keep clean, even in an agricultural environment that involves debris such as dirt or foliage. In FIG. 22, conveyor chains 188 are shown as cut off so that sprockets 186 are visible; it is to be understood that in operation, each chain 188 wraps in a continuous loop around sprockets 186 and associated machinery.

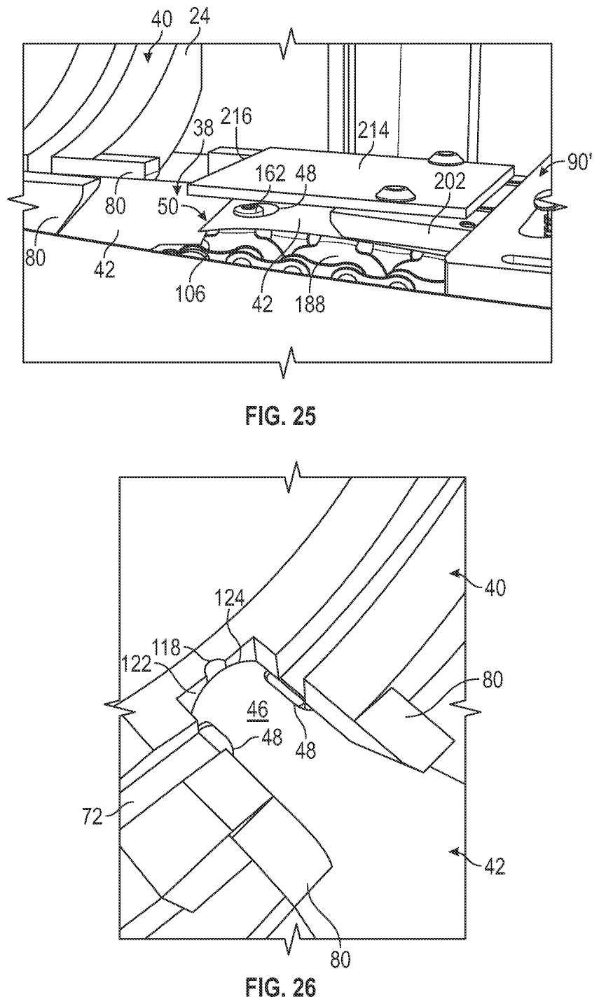

FIGS. 24-27 show structures at a ring end of the tag feeding assembly 26′. As shown in FIG. 24, ramp 210 with upwardly inclined surface 212 assists in lifting tag strip 38 off the pins 162, so that the tag strip does not follow the pins 162 as they turn downward along drive chain 188. Moreover, tag assembly 26′ may be operated to back up the tag strip 38 to assist in disengagement of the pins 162 from apertures 48. The structure of ramp 210 lifts and directs tag strip 38 toward the tag receiving portion 40 of ring 24. FIG. 25 shows a tag partition plate 214 connected to hold plate 202. Edge 216 of tag partition plate 214 is aligned with separation line 50 of tag strip 38. Thus, when the machine pulls on a twist tie 58 to cinch the twist tie around a product 36, 36′, this force pulls the separation line 50 against edge 216, which holds down the rest of the tag strip 38 as the tag 42 with a twist tie 58 through its apertures 48 is torn from the strip 38.

This disclosure describes non-limiting, exemplary embodiments, of a ring 24 configured for use in an automated tying machine 22 with a twist tie 58, a system 20 for automatically banding and tagging a product 36, and a strip 38 including a plurality of ruptureably connected tags 42. In an exemplary embodiment, a ring 24 includes a channel 72 through which the twist tie 58 is configured to travel and a first guide 74 having portions on proximal and distal sides of the channel 72. The first guide 74 comprises a tip 76 and first and second inclined sides 78 extending from the tip 76. In an exemplary embodiment, the tip 76 is rounded. In an exemplary embodiment, first and second fingers 80 are spaced from portions of the first and second inclined sides 78, respectively. In an exemplary embodiment, each of the first and second inclined sides 78 extends into a respective groove 79 of the ring 24. In an exemplary embodiment, each of the first and second fingers 80 includes a lower ramp surface 81 extending to its respective groove 79. In an exemplary embodiment, at least one of the first and second fingers 80 extends substantially perpendicular to the channel 72. Moreover, in an exemplary embodiment, a first guide or saddle 74 has a longitudinal extent that is aligned substantially perpendicular to the channel 72. In an exemplary embodiment, the ring 24 includes split 34 configured to allow an annulus of the ring 24 to open.

In an exemplary embodiment, a system 20 for automatically banding and tagging a product 36 includes a tying machine 22 configured to band the product 36 with a twist tie 58, the machine including a ring 24. The system 20 includes a tag feeding assembly 26 configured to position an attachment portion 46 of a tag 42 into the ring 24, wherein the attachment portion 46 is bent around the first guide 76 and against the first and second inclined sides 78, so that a twist tie 58 passing through the channel 72 passes through the attachment portion 46 of the tag 42.

In an exemplary embodiment, a tag insertion direction 82 of the tag 42 from the tag feeding assembly 26, 26′ into the ring 24 is substantially perpendicular to a twist tie travel direction 70 through the channel 72 at the tag receiving portion 40 of the ring 24. In an exemplary embodiment, a spool 30 is supported on the tying machine 22, wherein the tag 42 is one of a plurality of ruptureably connected tags 42 provided as a tag strip 38 rolled on the spool 30. An exemplary spool 30 can hold a wound strip 38 of about 10,000 connected tags 42, for example. In an exemplary embodiment, the tag strip 38 travels from the spool 30, around a guide roll 43, 43′ and to the tag feeding assembly 26, 26′. In an exemplary embodiment, the tag feeding assembly 26 includes a nip roller 62 and drive roller 88 advance the tag 42 into the ring 24.

In an exemplary embodiment, a strip 38 includes a plurality of ruptureably connected tags 42. In an exemplary embodiment, a tag 42 of the strip 38 is configured for use with twist tie 58 for assembly into a labeling assembly 84 in a ring 24 of an automated tying machine 22. In an exemplary embodiment, the tag 42 includes indicia 56 on a surface 52, 54 of the tag 42.

Although the subject of this disclosure has been described with reference to several embodiments, workers skilled in the art will recognize that changes may be made in form and detail without departing from the scope of the disclosure. In addition, any feature disclosed with respect to one embodiment may be incorporated in another embodiment, and vice-versa.

1. A ring configured for use with an automated tying machine with a twist tie and tag, the ring comprising:
a channel through which the twist tie is configured to travel;
a first guide comprising a tip and first and second inclined sides extending from the tip; and
first and second surfaces spaced from portions of the first and second inclined sides, respectively.

2. The ring of claim 1 in which at least one of the first and second surfaces is disposed on a finger that extends substantially perpendicular to the channel.

3. The ring of claim 1 comprising a split configured to allow an annulus of the ring to open.

4. The ring of claim 1, wherein the tip is rounded.

5. The ring of claim 1, wherein each of the first and second inclined sides extends into an associated groove of the channel.

6. The ring of claim 5 wherein at least one of the first and second surfaces extends to a respective groove.

7. The ring of claim 5, wherein the channel comprises a floor having a difference in elevation at one or more of the grooves.

8. The ring of claim 1 comprising a tag sensor.

9. A system for automatically banding and tagging a product, the system comprising:
a tying machine configured to band the product with a twist tie, the tying machine comprising a ring comprising:
a channel through which the twist tie is configured to travel; and
a guide comprising a tip and first and second inclined sides extending from the tip; and
a tag feeding assembly configured to position an attachment portion of a tag into the ring, wherein the attachment portion is bent around the guide and against the first and second inclined sides, so that the twist tie passing through the channel passes through the attachment portion of the tag.

10. The system of claim 9 wherein a tag insertion direction of the tag from the tag feeding assembly into the ring is substantially perpendicular to a twist tie travel direction through the channel.

11. The system of claim 9 comprising a spool supported on the tying machine, wherein the tag is one of a plurality of ruptureably connected tags provided as a tag strip rolled on the spool.

12. The system of claim 9 comprising a mobile platform on which the tying machine and tag feeding assembly are disposed.

13. A strip comprising a plurality of ruptureably connected tags, wherein:
a tag of the strip is configured for use with a ring in an automated tying machine with a twist tie, the ring comprising a channel through which the twist tie is configured to travel and a guide comprising a tip and first and second inclined sides extending from the tip;
wherein the tag comprises an attachment portion configured for insertion into the ring, wherein the attachment portion is configured to be bent around the guide and against the first and second inclined sides, so that a twist tie passing through the channel passes through the attachment portion of the tag.

14. The strip of claim 13 wherein the attachment portion of the tag comprises an aperture through which the twist tie passes.

15. The strip of claim 13, wherein the tag comprises indicia on a surface of the tag.
